(19) United States
(12) Patent Application Publication
(10) Pub. No.: US 2019/0152697 A1
(43) Pub. Date: May 23, 2019

(54) GARBAGE COMPRESSION DEVICE

(71) Applicant: Seun Kwon HAN, Seoul (KR)

(72) Inventor: Seun Kwon HAN, Seoul (KR)

(21) Appl. No.: 16/300,955

(22) PCT Filed: Apr. 12, 2018
(86) PCT No.: PCT/KR2018/004265

§ 371 Date: Nov. 13, 2018

(30) Foreign Application Priority Data
Apr. 12, 2017 (KR) 10-2017-0047144

(51) Int. Cl. B65F 1/14; B30B 1/32; B30B 15/30; B30B 15/32; B65F 1/16

(52) U.S. Cl. CPC B65F 1/1405; B30B 1/32; B30B 15/30; B65F 2210/184; B65F 1/16; B65F 2210/168; B65F 2210/162; B30B 15/32

(57) ABSTRACT

The present invention relates to a garbage compression device capable of maximizing the ease and efficiency of garbage collection and disposal by minimizing the volume of various types of garbage, such as food, paper, synthetic resins, or metallic materials, through compression thereof. The present invention comprises: a case in which an input port for garbage is formed on the upper portion thereof, and an output port for compressed garbage is formed on the lower portion thereof; a main body part which is installed inside the case and has a pipe shape, and in which an entrance port, into which the garbage input through the input port is entered, is formed on the upper portion thereof and a discharge port for the compressed garbage is formed on the lower end thereof; a compression part including a compression cylinder, which is installed on the upper end of the main body part, and a compression piston, which is provided in the compression cylinder and compresses the input garbage by being driven back and forth in the main body part through a driving member connected to the compression cylinder; and a gate part having a shape closely conforming to the side surface of the compression piston and protruding along the circumference of the inner side surface of the main body part below the entrance port.

### TECHNICAL FIELD

The present invention relates to a garbage compression device and more specifically, to a garbage compression device capable of maximizing the ease and efficiency of garbage collection and disposal by minimizing the volume of various types of garbage, such as food, paper, synthetic resins, or metallic materials, through compression thereof.

### DESCRIPTION OF THE RELATED ART

In general, various types of garbage such as food, paper, a synthetic resin or a metallic material, discharged by restaurants, fast food restaurants, large sores or schools etc., must be put into standardized plastic garbage bags and then discharged on a national level.

Preferably, the amount of discharged garbage needs to be reduced as part of an effort to reduce costs incurred for the purchase of plastic garbage bags. More preferably, the volume of discharged garbage is reduced as much as possible such that more garbage may be put into plastic garbage bags.

Garbage is usually pressed by hands or feet as a way to reduce the volume of the garbage. However, in this way, garbage is not effectively pressed and returns to its original shape after being compressed. Thus, garbage is hardly kept compressed.

### DETAILED DESCRIPTION OF THE INVENTION

### Technical Problems

The present invention is directed to providing a garbage compression device capable of compressing various types of garbage, such as food, paper, synthetic resins, or metallic materials that contain a small amount of moisture, so as to minimize the volume thereof even when the garbage is thrown away at a time, thereby making it possible to reduce the use of plastic garbage bags and relieve the financial burden on users, decrease frequency of transfer of garbage according to garbage collection, and maximize the convenience and efficiency in collecting and disposing of garbage.

### Technical Solutions

As a means to achieve the above-described purposes, a garbage compression device according to the present invention includes a case in which an input port for garbage is formed on the upper portion thereof, and an output port for compressed garbage is formed on the lower portion thereof; a main body part which is installed inside the case and has a pipe shape, in which an entrance port, into which the garbage input through the input port is entered, is formed on the upper portion thereof and in which a discharge port for the compressed garbage is formed on the lower end thereof; a compression part including a compression cylinder, which is installed on the upper end of the main body part, and a compression piston, which is provided in the compression cylinder and compresses the input garbage by being driven back and forth in the main body part through a driving member connected to the compression cylinder; and a gate part having a shape closely conforming to the side surface of the compression piston and protruding along the circumference of the inner side surface of the main body part at the lower side of the entrance port.

The compression piston has a cone shape, and the gate part may have a tapered shape whose front portion is narrowed and whose rear portion is widened with respect to the direction in which the compression piston is driven so as to correspond to the compression piston.

The gate part may include a plurality of gate protrusions protruding along the circumference of the inner side surface of the main body part.

The plurality of gate protrusions may have a portion, which protrudes towards the inner side of the main body and whose inner edge has a sharp trigonal pyramid shape, and a block surface 41a in which the lower end of the gate protrusion is inclined and further protrudes in the inward and downward directions of the main body part.

A garbage compression device according to the present invention may further include a tightening part which is installed at the lower portion of the main body part and reduces the inner diameter of the lower portion of the main body part.

The main body part includes a plurality of tightening pieces cut in the lengthwise direction thereof and formed at the lower portion thereof, and the tightening part may include a pair of clamps whose one ends are coupled to each other and which cover the plurality of tightening pieces, a tightening cylinder installed at the other end of any one of the pair of clamps, and a tightening rod provided to the tightening cylinder and pushing the other end of the clamp provided with the tightening cylinder so as to tighten the plurality of tightening pieces.

A garbage compression device according to the present invention further includes an opening and closing part which is installed at the lower portion of the main body part and opens and closes the discharge port, wherein the opening and closing part has a diameter corresponding to the inner diameter of the main body part and elastically swivels such that the end of the opening and closing part is caught by a bump provided on and protruding from the inner side surface of the main body part, thereby enabling the discharge port to be closed.

The input port, the output port and the entrance port are respectively provided with a door for opening and closing the input port, the output port and the entrance port, the main body part is provided with a first sensor at a position thereof, which corresponds to the entrance port, and the gate part may be provide with a second sensor at the upper side or the lower side thereof.

The driving member may further include a control part connecting with the first sensor and the second sensor.

### Advantageous Effects

According to the configuration of the present invention, various types of garbage such as food, paper, synthetic resins, or metallic materials that contain a small amount of moisture are compressed such that the volume of such garbage is minimized in the state where efficiency in compressing garbage is maximized, through a compression piston and a gate part that have shapes closely conforming to each other, and a tightening part or an opening and closing part that makes compressed garbage stagnate in a main body part for a pre-set period of time.

By doing so, the use of plastic garbage bags is reduced, the financial burden on users is relieved, frequency of transfer of garbage according to garbage collection is decreased, and the convenience and efficiency in collecting and disposing of garbage are improved.

Additionally, the efficiency in minimizing the volume of garbage is improved by means of gate protrusions whose inner edges protrude in the shape of a sharp trigonal pyramid, and garbage having been compressed is prevented from returning to the original shape thereof by means of block surfaces at the lower ends of the gate protrusions, thereby ensuring efficiency in compressing garbage.

Preferably, a case, configured to be compact in size and have an attractive appearance, may be installed in any place such as on the street, in a concert venue, in the playground, at a school store, at a festival or in a campsite etc. where many people gather because detailed components of a garbage compression device may be minimized.

Additionally, during the use of a garbage compression device, the garbage collecting member B (e.g. standardized plastic garbage bag) in which compressed garbage is piled is sealed at the lower portion of the main body part so as to block a bad smell from emitting, thereby ensuring hygiene.

Additionally, garbage is automatically compressed and collected, and the garbage compression device is easily manipulated, and prevented from malfunction and safety-related incidents because a garbage compression device operates only under pre-set conditions, by means of a driving member, first and second sensors connected with a control part.

Additionally, the garbage compression device is automatically driven without compressing garbage using labor force, and blocks damage done to a garbage collecting member.

Further, when doors for opening and closing an input port, an output port and an entrance port are configured to be transparent, the level at which garbage is compressed or the amount of piled garbage may be visibly confirmed, and when a display part connected with the control part is separately provided at the case, the level at which garbage is compressed may be monitored in real time, thereby ensuring convenience in using, managing and repairing the garbage compression device.

### BRIEF DESCRIPTION OF THE DRAWINGS

FIG. 1 is a perspective view schematically illustrating a garbage compression device according to the present invention.

FIG. 2 is a sectional view schematically illustrating an inner configuration of a garbage compression device according to the present invention.

FIG. 3 is a sectional view schematically illustrating part A in FIG. 2.

FIG. 4 is a sectional view schematically illustrating part B in FIG. 2.

FIG. 5 is a view schematically illustrating a gate protrusion of a garbage compression device according to the present invention.

FIG. 6 is a sectional view schematically illustrating part C in FIG. 2.

FIG. 7 is a sectional view schematically illustrating a garbage compression device according to another embodiment of the present invention.

### BEST MODE FOR CARRYING OUT THE INVENTION

A garbage compression device of the present invention includes a case 10 in which an input port for garbage 11 is formed on the upper portion thereof, and an output port for compressed garbage is formed on the lower portion thereof; a main body part 20 which is installed inside the case 10, has a pipe shape, has an entrance port 21, into which the garbage input through the input port 11 is entered, formed on the upper portion thereof and has a discharge port 22 for the compressed garbage is formed on the lower end thereof; a compression part 30 including a compression cylinder 31 installed on the upper end of the main body part 20, and a compression part 30 which is provided in the compression cylinder 31, compresses the input garbage by being driven back and forth in the main body part 20 through a driving member connected to the compression cylinder 31 and has a cone shape; and a gate part 40 which has a shape closely conforming to the side surface of the compression piston 32 and protrudes along the circumference of the inner side surface of the main body part 20 at the lower side of the entrance port 21.

The gate part 40 has a tapered shape whose front portion is narrowed and whose rear portion is widened with respect to the direction in which the compression piston 32 is driven, so as to correspond to the compression piston 32, and has a plurality of gate protrusions 41 protruding along the circumference of the inner side surface of the main body part 20.

The plurality of gate protrusions 41 have a portion, which protrudes towards the inner side of the main body 20 and whose inner edge has a sharp trigonal pyramid shape, and a block surface 41a in which the lower end of the gate protrusion is inclined and further protrudes in the inward and downward directions of the main body part.

### MODE FOR CARRYING OUT THE INVENTION

The components and relationship between the components of preferred embodiments of the present invention will be described with reference to the attached drawings so as to achieve the above-described purposes, and technical configurations the same as conventional ones or included in the same scope of conventional ones will be omitted.

The present invention relates to a garbage compression device capable of maximizing the ease and efficiency in garbage collection and disposal, by compressing various types of garbage, such as food, paper, synthetic resins, or metallic materials that contain a small amount of moisture so as to minimize the volume thereof on the street, in a concert venue, in the playground, at a school store, at a festival or in a campsite etc. where many people gather.

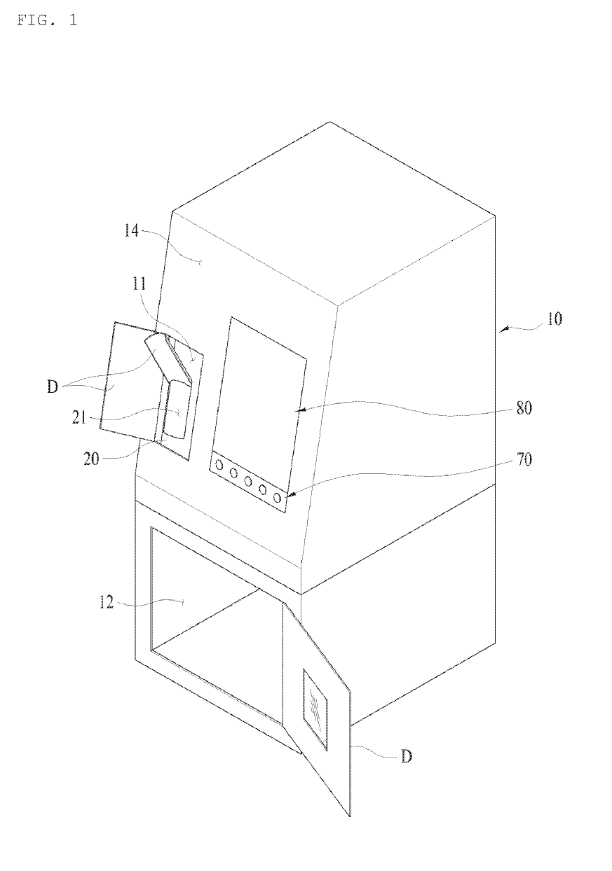

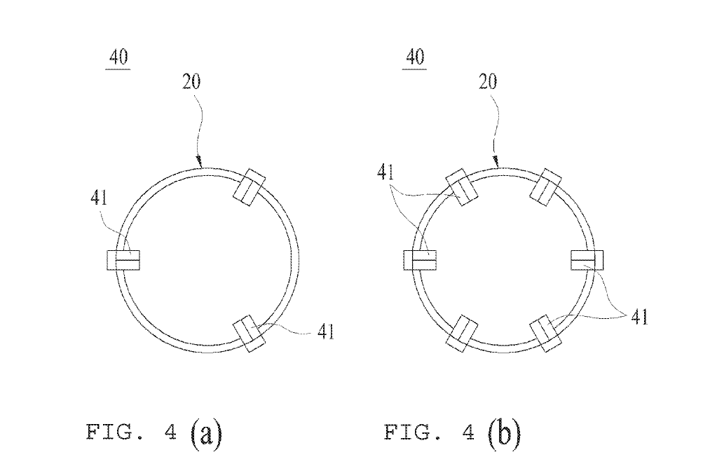

To this end, a garbage compression device of the present invention, as illustrated in FIGS. 1 to 6, includes a case 10, a main body part 20, a compression part 30 and a gate part 40.

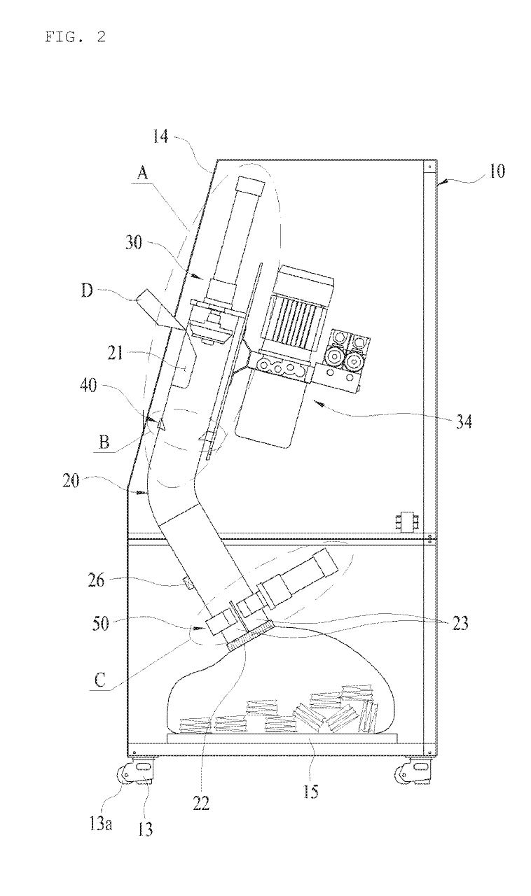

The case 10, as illustrated in FIGS. 1 to 2, may have various shapes. For instance, the appearance of a garbage compression device may have the shape of a rectangular box with a predetermined size and height so as to compress garbage inside thereof. Additionally, the garbage compression device may include the main body part 20, the compression part 30 and the garbage collecting member B etc. that will be described hereunder inside thereof.

Preferably, the case 10 is configured to be compact in size and have an attractive appearance so as to be readily installed in any place such as on the street, in a concert venue, in the playground, at a school store, at a festival or in a campsite etc. where many people gather because below-described detailed components, which are installed in a garbage compression device so as to constitute the same, may be minimized.

Additionally, the case 10 includes an input port 11 formed on the upper portion thereof so as to input garbage. The input port 11 is formed at a position of the case, which corresponds to an entrance port 21 of the below-described main body part 20, and is linked with the entrance port 21 such that input garbage is introduced into the main body part 20 through the entrance port 21.

The case includes a door D for opening and closing the input port 11 on the front surface of the case 10 so as to correspond to the input port 11. The door D may be configured to be transparent such that the question as to whether garbage is properly input through the input port 11 is confirmed. Additionally, the door of the entrance port 21 that will be described hereunder may be configured to be transparent so as to confirm that a compression piston 32 is driven back and forth.

Additionally, the case 10 includes an output port 12 which is formed on the lower portion thereof and outputs compressed garbage contained in the garbage collecting member B that will be described hereunder, and includes a door D for opening and closing the output port 12 on the front surface of the case 10 so as to correspond to the output port 12. Further, the door D may be configured to be transparent so as to visibly confirm the amount of piled garbage.

Additionally, the case 10 is provided with a plurality support members 13 on the bottom surface thereof so as to support the load of the case 10 put on the ground of a place where the case is installed, and the support member 13 is preferably provided with a wheel 13a such that a garbage compression device is easily moved.

Additionally, the case 10 preferably has an inclined upper portion such that garbage is easily input through the input portion 12 while the below-described main body part 10 also may have the shape of a pipe having an inclined upper portion so as to correspond to the front surface of the upper portion of the case 10.

Additionally, the case 10 is provided with a weighing scale 15, on which the below-described garbage collecting member B is put, on the inner bottom surface thereof. The weighing scale 15 is connected to the below-described control part 70 and display part 80 so as to gage the weight of a garbage collecting member B in which garbage is piled so as to control the drive of a device and to recognize the time when garbage is collected.

Meanwhile, as illustrated in FIGS. 1 to 4, 6 and 7, the main body part 20 has the shape of a pipe whose inside is hollow and is installed inside the case 10, and the upper portion of the main body part 20 is configured as an inclined straight pipe so as to correspond to the shape of the case 10 whose upper front surface is inclined. The main body part may have the shape of a pipe that is vertical, horizontal or inclined so as to smoothly operate with respect to the below-described compression part 30.

Additionally, when the upper portion of the main body part 20 is inclined so as to correspond to the front surface of the upper portion of the case 10, the lower portion of the main body part 20 may also be inclined so as to correspond to the upper portion of the main body part. In this case, a usual elbow pipe may be further included so as to connect the upper and lower portions of the main body part 20, which are configured as inclined straight pipes, and may be configured as a usual duct so as to compress garbage and smoothly discharge compressed garbage by means of the drive of the below-described compression part 30.

Additionally, the lower portion of the main body part 20 corresponding to the upper portion thereof may be selectively configured as a vertical, horizontal or inclined pipe so as to smoothly discharge garbage. Such a main body part 20 may be configured as a duct whose upper and lower portions are integrally formed unlike a main body part whose upper and lower portions separable are connected by a usual elbow pipe.

Additionally, a separate protection member is preferably applied and welded to the inner side surface of the main body part 20 so as to prevent damage such as corrosion etc. due to moisture contained in garbage.

Additionally, the main body part 20 includes an entrance port 21 at a position of the upper portion thereof, which corresponds to the above-described input port 11, such that the entrance port is linked with the input port 11, thereby enabling garbage input through the input port 11 to be inserted into the main body part 20.

The main body part 20 includes a door D for opening and closing the entrance port 21 at a position of the side surface thereof, which corresponds to the entrance port 21. When the door D is configured to be transparent, the question as to whether garbage is properly input, and whether the below-described compression piston 32 is driven back and forth may be confirmed even in the state where the entrance port is closed 21.

Additionally, the main body part 20 may include a first sensor 25, connected with the below-described control part 70, at a position thereof, which corresponds to the entrance port 21. The first sensor 25 is used to confirm the closing and opening of the entrance port 21. In the case in which the compression part 30 is already set to operate only when the entrance port 21 is closed, the compression part may be prevented from malfunction or causing safety-related incidents. Further, the device may be easily driven.

Additionally, the main body part 20 has an opened lower end and includes a discharge port 22 for discharging compressed garbage at the lower end thereof formed on the lower end thereof, and a garbage collecting member B such as a standardized plastic garbage bag is detachably coupled to the discharge port 22.

That is, garbage, compressed by means of the drive of the below-described compression part 30, is smoothly introduced into the garbage collecting member B using the self-weight thereof through the discharge port 22.

The garbage collecting member B covers the lower end of the main body part 20, which corresponds to the discharge port 22, and is coupled to the same by means of fastening or clamping etc. During the use of the device, the garbage collecting member B in which compressed garbage is piled is sealed at the lower portion of the main body part 20 so as to block a bad smell from emitting, thereby ensuring hygiene.

The garbage collecting member B is arranged on the weighing scale 15. Additionally, the weighing scale 15 connected with a control part 70 and a display part 80. When a user senses that the garbage collecting member weighs a pre-set weight through the weighing scale 15 connected with a control part 70 and a display part 80, the user opens the output port 12 and collects garbage from the case 10.

Additionally, the main body part 20 may be provided with a second sensor 26 on the upper side or lower side of the below-described gate part 40. The second sensor 26 is connected with a control part 70 and senses the pressure at the upper portion inside the main body part 30, the pressure at the lower portion inside the main body part 30 according to the drive of the below-described compression part 30, or the position of garbage piled at the lower portion inside the main body part 30, so as to deliver the same to a control part 70.

By doing so, the below-described control part 70 senses whether a pre-set input value is reached or where garbage is positioned and controls a driving member 34 connected with the control part so as to control the forward and backward drive of the below-described compression piston 32. A value, delivered to the control part 70 and measure by the second censor 26, is displayed on the below-described display part 80 and monitored in real time.

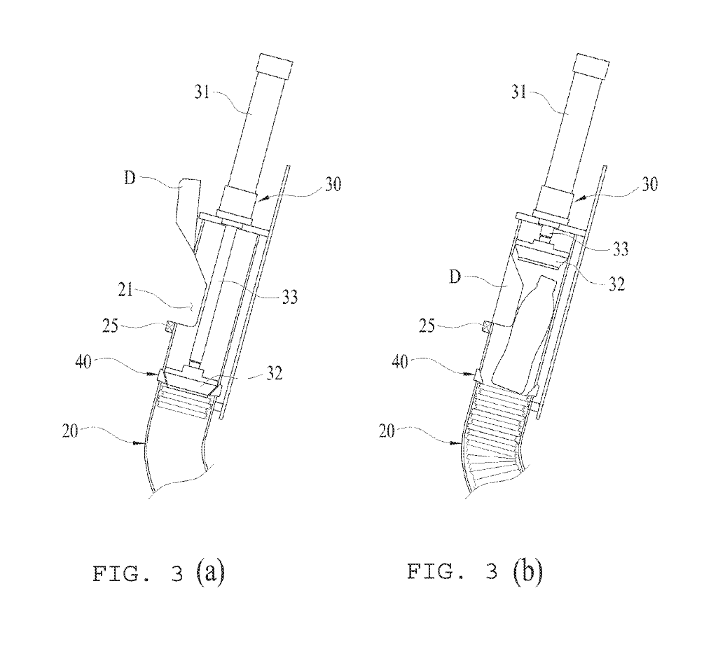

Meanwhile, a compression part 30, as illustrated in FIGS. 2 and 3, compresses garbage input through the entrance port 21 inside the main body part 20 and includes a compression cylinder 31 installed on the upper end of the main body part 20, and a compression piston 32 provided in the compression cylinder 31 and compressing input garbage by being driven back and forth in the main body part 20 through a driving member connected to the compression cylinder 31.

Additionally, the compression part 30 is provided with a compression rod 33 connecting the compression cylinder 31 and the compression piston 32, and the driving member 34 is connected with the compression cylinder 31 through a pipe or a hose and may be configured as a pump so as to provide hydraulic or pneumatic pressure to the compression cylinder 31.

Because the driving member 34 is connected with the below-described control part 70, the compression piston 32 of the compression part 30 may be driven forward when the entrance port 21 is closed by the first sensor 25 so as to compress garbage while being driven backward by means of the pressure at the lower portion inside the main body part 30 or the position of piled garbage sensed by the second sensor 26.

Thus, garbage may be automatically compressed and discharged through the discharge port 22. As a result, garbage may be collected through the garbage collecting member B, and a garbage compression device may be easily manipulated and may be driven only under pre-set conditions so as to be prevented from malfunction or safety-related incidents.

In particular, the compression piston 32 of a garbage compression device according to the present invention has a shape corresponding to the inner diameter of the main body part 20 having a pipe shape. Thus, the side surface of the compression piston is driven back and forth while closely contacting the inner side surface of the main body part 20, wherein the compression piston has the shape of a cone whose front portion is narrowed and whose rear portion is widened such that the diameter of the compression piston becomes narrower towards the front thereof with respect to the direction in which the compression piston is driven back and forth.

Further, the below-described gate part 40 is configured to closely correspond to the side surface of the compression piston 32. Thus, pressure is concentrated toward the front portion having a concave shape at an inner portion of the main body part 20 at the lower side of the entrance port 21, to which pressure is virtually applied, thereby improving efficiency in compressing garbage.

By doing so, various types of garbage such as food, paper, synthetic resins, or metallic materials that contain a small amount of moisture are compressed such that the volume of such garbage is minimized in the state where efficiency in compressing garbage is maximized. Thus, reduced use of plastic garbage bags helps relieve the financial burden on users, decrease frequency of transfer of garbage according to garbage collection and improve the convenience and efficiency in collecting and disposing of garbage.

Preferably, the compression piston 32 has a narrowed front portion and a widened rear portion such that the diameter of the compression piston is narrowed from the upper end thereof, and has a diameter such that the compression piston 32 may closely contact and pass through the inner space constituted by the below-described gate part 40 at the lower end thereof. By doing so, garbage closely contacted and compressed by the gate part 40 passes through the inner space constituted by the gate part 40 as if the garbage is press-fitted. Thus, compressed garbage is prevented from moving toward the upper side of the gate part 40 again, or the shape of compressed garbage is prevented from being restored.

Meanwhile, the gate part 40, as illustrated in FIGS. 2 to 5, is configured to closely conform to the side surface of the compression piston 32 and configured to protrude along the circumference of the inner side surface of the main body part 20 at the lower side of the entrance port 21 such that garbage may be efficiently compressed by the compression piston 32.

Like the compression piston 32, the gate part 40 has a tapered shape whose front portion is narrowed and whose rear portion is widened with respect to the direction in which the compression piston 32 is driven. By doing so, pressure is concentrated toward the front portion having a concave shape at an inner portion of the main body part 20 at the lower side of the entrance port 21 such that garbage positioned between the compression piston 32 and the gate part 40 may be compressed in the state where efficiency in compressing garbage is improved.

Additionally, the gate part 40 may include a plurality of gate protrusions 41 protruding along the circumference of the inner side surface of the main body part 20. Preferably, the inner side surface of each gate protrusion 41 has a shape that is tapered in the inward and downward directions of the main body part such that the inner side space constituted by the gate protrusions 41 has a narrowed front portion and a widened rear portion.

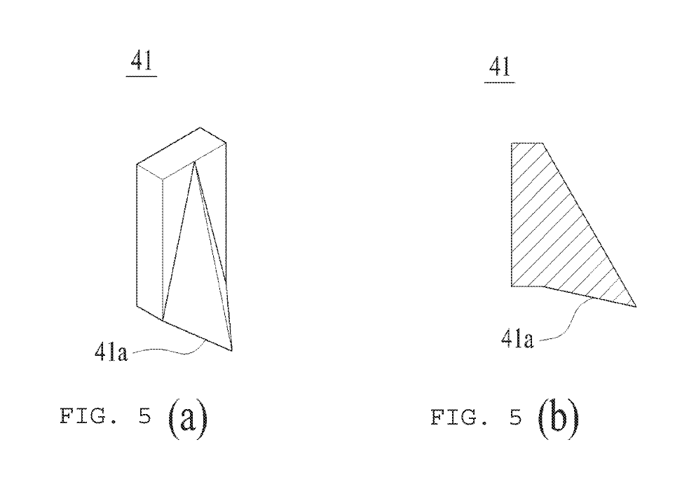

Herein, the plurality of gate protrusions 41, as illustrated in FIG. 5, have a portion, which protrudes towards the inner side of the main body 20 and whose inner edge has a sharp trigonal pyramid shape, and a block surface 41a in which the lower end of the gate protrusion is inclined and further protrudes in the inward and downward directions of the main body part.

By doing so, the edge of garbage compressed by the compression piston 32 is pressed by the edges of the inner sides of the gate protrusions 41 and closely contacts the sharp edges of the gate protrusions 41 while the garbage falls toward the discharge port 22. Thus, the edge of the garbage is torn or cur thereby making it possible to improve efficiency in reducing the volume of the garbage. Further, the garbage whose edge is torn or cut may not return to the original shape thereof. Thus, the volume of garbage, reduced following the compression of garbage, may be maintained.

Additionally, garbage having been press-fitted and having passed through the inner side space constituted by the gate part 40 be means of the lower end of the compression piston 32 is caught by a block surface 41a formed at the lower ends of the gate protrusions 41 such that garbage having been compressed is prevented from moving upward and from returning to the original shape thereof, thereby ensuring efficiency in compressing garbage.

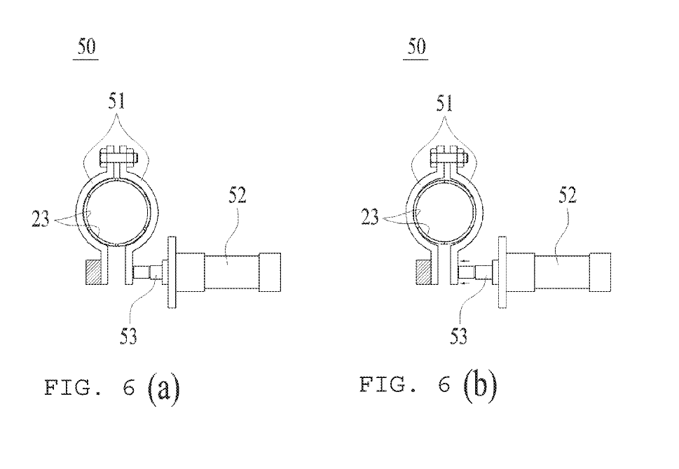

Meanwhile, a garbage compression device according to the present invention, as illustrated in FIGS. 2 and 6, may further include a tightening part 50 that is installed at the lower portion of the main body part 20 and reduces the inner diameter of the lower portion of the main body part 20.

The tightening part 50 may include a pair of clamps 51 whose one ends are coupled to each other and which cover a plurality of tightening pieces 23 cut in the lengthwise direction of the main body part and formed at the lower portion of the main body part 20 including the lower end thereof, a tightening cylinder 52 installed at the other end of any one of the pair of clamps 51, a tightening rod 53 provided to the tightening cylinder 52 and pushing the other end of the clamp 51 provided with the tightening cylinder 52 so as to tighten the plurality of tightening pieces 23.

Herein, the tightening cylinder 52 may be connected with the driving member 34 and connected with a separate driving source connected with the below-described control part 70 so as to pull and push the tightening rod 53.

In the state where the inner diameter of the lower portion of the main body part 20 is reduced by pushing the other ends of the clamps 51 and tightening the tightening pieces 23 through the tightening part 50, when garbage is continuously compressed, the garbage compressed by the reduced inner diameter of the lower portion of the main body part 20 is not discharged through the discharge port 22 and piled between the gate part 40 and the tightening part 50.

Thus, the garbage stagnating and piled between the gate part 40 and the tightening part 50 may be more intensely compressed, thereby improving efficiency in compressing garbage and making it possible to steadily keep garbage compressed through the improved efficiency in compressing garbage.

Additionally, when the state where compressed garbage is kept stagnating and piled is maintained, and then the second sensor 26 senses that the pressure between the gate part 40 and the tightening part 50 is larger than the pressure applied by the compression piston 32 or that garbage is piled up to a pre-set height, the below-described control part 70 displays this on a display part 80 and simultaneously and pulls the tightening rod 53 so as to return the reduced inner diameter of the lower portion of the main body part 20 to the original state thereof, thereby allowing piled garbage to be discharged.

The tightening part 50 includes the clamp 51, the tightening cylinder 52 and the tightening rod. In addition, the tightening part may be replaced with a usual band brake (invisible) which is provided at the lower portion of the main body part and covers the same, and any device configured to reduce and restore the diameter of the lower portion of the main body part 20 may be selectively applied.

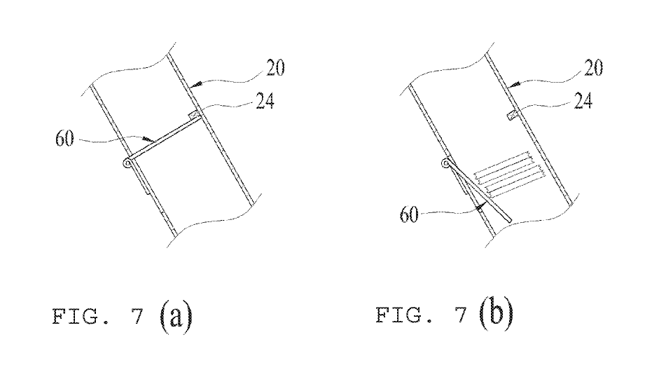

Meanwhile, a garbage compression device according to the present invention, as illustrated in FIG. 7, may further include an opening and closing part 60 that is installed at the lower portion of the main body part 20 and opens and closes the discharge port 22.

The opening and closing part 60 has a diameter corresponding to the inner diameter of the main body part 20 and elastically swivels, such that the end of the opening and closing part is caught by a bump 24 provided on and protruding from the inner side surface of the main body part 20, thereby enabling the discharge port 22 at the lower end of the main body part 20 to be closed.

As described above, the discharge port 22 is closed for a certain period of time. Because the effect of the stagnating and piling of compressed garbage on the opening and closing part 60 at the lower side of the gate part 40 is the same as or similar to the effect brought by the tightening part 40, description of the opening and closing part 60 will be omitted.

When garbage is piled on the opening and closing part 60 for a certain period of time and then the opening and closing part 60 may not withstand the load of the piled garbage, the opening and closing part 60 naturally swivels downward, and the piled garbage falls toward the opened discharge port 22 so as to be piled in the garbage collecting member B. After the piled garbage is discharged, the opening and closing part 60 swivels upward by means of the elasticity thereof, and the end of the opening and closing part is caught by a bump 24 so as to close the discharge port 22 again.

The upper and lower sides of the opening and closing part 60 may swivel by means of the elasticity thereof, as described above, and by means of the sensing of pressure, or height at which garbage is piled by the second sensor 26, by connecting with the below-described control part 70.

Meanwhile, the control part 70 is installed in the case 10 and connected with the driving member 34, the first sensor 25 or the second sensor 26 etc. so as to control the drive of a garbage compression device.

By doing so, the driving member 34 may be controlled on the basis of pre-set conditions sensed by the first sensor 25 or the second sensor 26 such as whether the entrance port 21 is opened or closed, whether the compression piston 32 is driven, the level at which garbage is compressed, pressure respectively on upper and lower sides of the gate part 40 or the height at which garbage is piled etc.

Information transmitted by the first sensor 25 and the second sensor 26 to the control part 70 may be displayed on the display part 80 connected with the control part 70.

Therefore, garbage is automatically compressed and collected, and a garbage compression device is easily manipulated, prevented from malfunction and safety-related incidents because a garbage compression device operates only under pre-set conditions, automatically driven without compressing garbage using labor force, blocks damage done to a garbage collecting member, and easily managed and repaired by enabling a user to monitor the level at which garbage is compressed through a display part 80 in real time.

It should be understood that the embodiments set forth herein are provided only as examples, and the present invention is not limited to the embodiments. Further, it should be understood that anything that has configurations and effects substantially the same as those described in the appended claims of the present invention is included in the technical spirit and scope of the present invention.

1. A garbage compression device comprising:
a case (10) in which an input port (11) for garbage is formed on the upper portion thereof, and an output port (12) for compressed garbage is formed on the lower portion thereof;
a main body part (20) which is installed inside the case (10) and has a pipe shape, in which an entrance port (21), into which the garbage input through the input port (11) is entered, is formed on the upper portion thereof and in which a discharge port (22) for the compressed garbage is formed on the lower end thereof;
a compression part (30) including a compression cylinder (31), which is installed on the upper end of the main body part (20), and a compression piston (32), which is provided in the compression cylinder (31) and compresses the input garbage by being driven back and forth in the main body part (20) through a driving member (34) connected to the compression cylinder (31); and
a gate part (40) having a shape closely conforming to the side surface of the compression piston (32) and protruding along the circumference of the inner side surface of the main body part (20) at the lower side of the entrance port (21),
wherein the gate part (40) has a tapered shape whose front portion is narrowed and whose rear portion is widened with respect to the direction in which the compression piston (32) is driven so as to correspond to the compression piston (32), and comprises a plurality of gate protrusions (41) protruding along the circumference of the inner side surface of the main body part (20), and
the plurality of gate protrusions (41) have a portion, which protrudes towards the inner side surface of the main body (20) and whose inner edge has a sharp trigonal pyramid shape, and a block surface (41a) in which the lower end of the gate protrusion is inclined and further protrudes in the inward and downward directions of the main body part.

2. A garbage compression device comprising:
a case (10) in which an input port (11) for garbage is formed on the upper portion thereof, and an output port (12) for compressed garbage is formed on the lower portion thereof;
a main body part (20) which is installed inside the case (10) and has a pipe shape, in which an entrance port (21), into which the garbage input through the input port (11) is entered, is formed on the upper portion thereof and in which a discharge port (22) for the compressed garbage is formed on the lower end thereof;
a compression part (30) including a compression cylinder (31), which is installed on the upper end of the main body part (20), and a compression piston (32), which is provided in the compression cylinder (31) and compresses the input garbage by being driven back and forth in the main body part (20) through a driving member (34) connected to the compression cylinder (31); and
a gate part (40) having a shape closely conforming to the side surface of the compression piston (32) and protruding along the circumference of the inner side surface of the main body part (20) at the lower side of the entrance port (21),
wherein the garbage compression device further comprises an opening and closing part (60) which is installed at the lower portion of the main body part (20) and opens and closes the discharge port (22), and
the opening and closing part (60) has a diameter corresponding to the inner diameter of the main body part (20) and elastically swivels such that the end of the opening and closing part is caught by a bump (24) provided on and protruding from the inner side surface of the main body part (20), thereby enabling the discharge port (22) to be closed.

3. The garbage compression device according to claim 1, further comprising:
a tightening part (50) which is installed at the lower portion of the main body part (20) and reduces the inner diameter of the lower portion of the main body part (20).

4. The garbage compression device according to claim 3,
wherein the main body part (20) comprises a plurality of tightening pieces (23) cut in the lengthwise direction thereof and formed at the lower portion thereof, and
the tightening part (50) comprises a pair of clamps (51) whose one ends are coupled to each other and which cover the plurality of tightening pieces (23), a tightening cylinder (52) installed at the other end of any one of the pair of clamps (51), and a tightening rod (53) provided to the tightening cylinder (52) and pushing the other end of the clamp (51) provided with the tightening cylinder (52) so as to tighten the plurality of tightening pieces (23).

5. The garbage compression device according to claim 1,
wherein the input port (11), the output port (12) and the entrance port (21) is respectively provided with a door D for opening and closing the input port, the output port and the entrance port, and
the main body part (20) is provided with a first sensor (25) at a position thereof, which corresponds to the entrance port (21), and the gate part (40) is provide with a second sensor (26) at the upper side or the lower side thereof.

6. The garbage compression device according to claim 5,
wherein the driving member (34) further comprises a control part (70) connecting with the first sensor (25) and the second sensor (26).

7. The garbage compression device according to claim 2, further comprising:
a tightening part (50) which is installed at the lower portion of the main body part (20) and reduces the inner diameter of the lower portion of the main body part (20).

8. The garbage compression device according to claim 7,
wherein the main body part (20) comprises a plurality of tightening pieces (23) cut in the lengthwise direction thereof and formed at the lower portion thereof, and
the tightening part (50) comprises a pair of clamps (51) whose one ends are coupled to each other and which cover the plurality of tightening pieces (23), a tightening cylinder (52) installed at the other end of any one of the pair of clamps (51), and a tightening rod (53) provided to the tightening cylinder (52) and pushing the other end of the clamp (51) provided with the tightening cylinder (52) so as to tighten the plurality of tightening pieces (23).

9. The garbage compression device according to claim 2,
wherein the input port (11), the output port (12) and the entrance port (21) is respectively provided with a door D for opening and closing the input port, the output port and the entrance port, and
the main body part (20) is provided with a first sensor (25) at a position thereof, which corresponds to the entrance port (21), and the gate part (40) is provide with a second sensor (26) at the upper side or the lower side thereof.

10. The garbage compression device according to claim 9,
wherein the driving member (34) further comprises a control part (70) connecting with the first sensor (25) and the second sensor (26).
